(19) United States
(12) Patent Application Publication
(10) Pub. No.: US 2007/0287938 A1
(43) Pub. Date: Dec. 13, 2007

(54) Self-leveraging U-shaped back-massager w/accessory options

(76) Inventor: David H. Shields, Van Nuys, CA (US)

Correspondence Address: David H. Shields, 15942 Blythe Street, Van Nuys, CA, 91406, US

(21) Appl. No.: 11/449,877

(22) Filed: Jun. 9, 2006

(51) Int. Cl. A61H 15/00; A61H 1/00

(52) U.S. Cl. 601/15; 601/118; 601/46

(57) ABSTRACT

A hand-portable manually operated back-massager, the U-Massage™ implement comprises a rigid frame critically configured as to facilitate a unique advantageous transitional-fulcrum principle, —whereby user can easily induce a much greater amount of massage-pressure and acupressure as well if desired. The basic notion of my transitional-fulcrum employs a gliding shoe mounted at the lower-terminus of my inverted J-shaped implement's front-leg, whereby the user is enabled to merely tilt the upper portion of the implement forward as to thereby realize a tremendous leverage advantage upon their back as the masssage-roller arranged at the lower-terminus of the implement's back-leg is caused to thrust into the user's back-musculature with far greater emphasis as compared to conventional back-massagers of this sort. While including a number of accessory options, including both motorized and heated iterations, serving to substantially enhance the functional scope and effectiveness of my basic instrument; —my disclosure also sets forth generic-variant embodiments better facilitating usage by persons of greater body variances, as well as folding in a spatially compact manner.

### I.) BACKGROUND OF THE INVENTION

1. Field of Invention

This invention relates to manually operated self-administered back-massaging implements, and more specifically it relates to those types employing a U-shaped configuration for reaching around to massage ones lower-back region.

2. Relevant Prior-Art

Over the course of centuries man has invented various implements devised to self-administer a massaging action to one's back as a remedial procedure addressing various ailments, owing that one's spinal-column and integral nerves branch out to various bodily-organs and proximal associated musculature. As result of on-going observation and study, It has been understood for centuries that the harmony of these bodily components is critical to one's maintaining a healthy and comfortable condition.

Background research discovery provides some prior patent-art regarded as germane to this disclosure, chronologically for example U.S. Pat. No. 869,250 (filed: July 1906) contemplates an elementary back-scratcher, comprised of an elongate resiliently flexile and longitudinally bowed arm portion approximately 18-inch in length, including a looped handle fixed at its upper/distal-end. The lower/distal-end the arm is provided with a pivot-axis arranged as to point toward one's back, to which is installed a rotatable gripper suitably configured as to hold a mild-abrasive such as a dried remnant of corn-cob for example. Accordingly, the user can manipulate the distal corn-cob against their back as may be desired to achieve a soothing treatment upon the otherwise unreachable region of one's back. However, because of the lack of leverage, it is not possible to induce a great amount of roller-pressure against one's back.

In the German/Pat.#294,863 (filed August 1915) is shown the next known progression, as a multi-purpose implement, —employing a similarly slightly arched arm which overlapping lengths of flexile metal are slidingly adjustable for custom reach, the upper/distle-end thereof having a handle; however, the lower/distal-end is bifurcated, as to support an axle holding either a plurality of rollers, or a single ball, or a brush as may be preferred. However, because of the lack of leverage, it is not possible to induce a great amount of roller-pressure against one's back.

In U.S. Pat. No. 1,533,528 (filed: October 1923) is shown a massage implement comprising an arched semi-rigid arm having a massage roller arranged upon a central-axis thereto, and a hand grips tethered to its opposite distal-ends. The roller is made demountable so as to enable interchangability with a variety of deferent roller shapes. The massage-implement is used by arranging it transversely across one's back, and is moved up and down by raising and lowering one's laterally extended arms. However, because of the lack of leverage, it is not possible to induce a great amount of roller-pressure against one's back.

In U.S. Pat. No. 1,612,343 (filed: June 1925) is shown a rigid inverted-U shaped massaging implement in which the U-bend is fixed at from 120-degrees to 190-degrees, and includes a handle portion at the distal end of its longer-leg, a massaging-nub at the opposite distal end. A medial hand-grip is arranged at the U-shaped portion, whereby the user's hand thereby acts as a fulcrum-point, thereby rocking the massaging-nub into one's back when the handle is forced away from their body. However, because the hand maintained fulcrum-point has very limited travel, it is possible only to massage a limited area of one's back.

In German Pat.#496,086 (filed: September 1930) is shown a rigid L-shaped massaging implement, having a handle at the distal-end of its long-leg, and a pair of ball-shaped massaging-rollers mounted upon an axle arranged transversely at the distal-end of its short-leg. The rollers are shaped like 45-degree ellipses in cross-section, and have special wobble inducing axle-bearings, —thereby inducing an enhanced massaging effect as they rotate along one's back; however, because of the lack of leverage enablement, it is not possible to induce a great amount of roller-pressure upon one's back.

In U.S. Pat. No. 185,246 (filed: January 1959) is shown a rigid semi-circular hook-shaped massaging implement, having a ball-shaped handle at the distal-end of its long-leg, and a pair of multi-tipped massaging-rollers mounted upon an axle arranged transversely at the distal-end of its curved-arm portion. However, because of the lack of leverage enablement, it is not possible to induce a great amount of roller-pressure upon one's back.

In U.S. Pat. No. 3,856,002 (filed: August 1973) is shown a rigid inverted-U shaped compact massaging implement for the upper-back regions, and having a spring mounted circular-pad like massaging-head arranged at the aftward terminus, and a handle arranged at its opposite distal-end; the handle being pivotally mounted to the forward terminus, thereby enabling the user to alter the anglarity of the hand-tool via 30-degree/detent-increments, hence the pitch of the massage-head. However, because of the lack of leverage enablement, it is not possible to induce a great amount of roller-pressure upon one's back.

In U.S. Pat. No. 4,091,805 (filed: March 1977) is shown a vibrating hand which finger-tips function more as a soothing back-scratcher than massager, and features an aftwardly extending straight tubular extension terminating into a handle housing a coaxial solenoid-motor acting through an off/on-switch to linearly rapidly oscillate the hand.

In U.S. Pat. No. 4,266,536 (filed: December 1978) is ahown a back-massager having an S-shaped tubular member having an upturned frontal control-handle, while terminating aftwardly with a coaxial-axis supporting a transverse-axle, thus enabling a roller(smooth or knurled tread surface) to freely caster thereto; plus, teaches optional inclusion of a vibrator-motor which rotational-axis is concentric with and proximal to said coaxial-axis. Since the drawings clearly show an air-gap between the vertically-curved tubular member and the user's frontal-abdomen, and no mention is given at all in the specification as to the implement employing any suitable manner of achieving a leveraging advantage; —the claim-1(col.-3/line 24) thus erroneously eludes to “a first curved portion forming a fulcrum for resting against the user's front side”; moreover, nor is any mention given in the specification as to a ‘first-curved portion’. Also, the curvature-references (col.-2/line-50) “r1 & r2” are absent from the drawings; —therefore in total, rendering the claim of “fulcrum” essentially specious, owing the implement is clearly shown being manipulated forwardly between two spaced apart handle positions relative to the aft impingement point of the roller.

In U.S. Pat. No. 4,798,198 (filed: January 1988) is shown a C-shaped massaging implement, whereto one terminus has a transverse-axis supporting a massage-roller, while the opposing terminus of the implement is formed into a tapering nub for application of acupressure to one's back however, because of the lack of leverage enablement, it is not possible to induce a great amount of massage-pressure upon one's back.

In U.S. Pat. No. 326,721 (filed: November 1989) is shown a crook like massaging implement having a handle at one terminus and an extending dog-leg having a C-shaped outer portion with a blunt terminus. However, because of the lack of leverage enablement, it is not possible to induce a great amount of massage-pressure upon one's back.

In U.S. Pat. No. 5,530,983 (filed: July 1994) is shown a U-shaped massaging implement having a handle at its forward terminus, and including interchangeable attachments such as a brush, wooden nub-cluster, and a electrical or chemically activated heating-pad. However, because of the lack of leverage enablement, it is not possible to induce a great amount of massage-pressure upon one's back.

In U.S. Pat. No. 5,560,746 (filed: October 1996) is shown a J-shaped acupressure application implement having an elongate forward extending leg portion terminating into various optional handle configurations, while the short forward projecting leg's terminus is adapted to provide a pressure-nub (which is preferably a known 3 k-gauss magnet plated with the constituents of various defined ‘catlytic’ trace-elements) that is manually worked upon nerve regions of ones back. However, because of the lack of leverage enablement, it is not possible to induce a great amount of massage-pressure upon one's back.

Therefore, in full consideration of the preceding patent review, there is determined a need for an improved form of device to which these patents have been largely addressed. The instant inventor hereof believes their newly improved back-massager device, commercially referred to as the U-Massage™, and currently being developed for production under auspices of the Shields-Mfg./Mkt.Co., exhibits certain advantages as shall be clearly revealed in the subsequent portion of this instant disclosure.

### II.) SUMMARY OF THE INVENTION

A.) In view of the foregoing discussion about the earlier invention art, it is therefore important to make it pellucid to others interested in the art that the object of this invention disclosure is to set forth novel features of my U-Massage™, an improved back massager implement critically configured as to enable the user to exercise an advantageous transitional-fulcrum principle, —for easily inducing a greater amount of massage-pressure, and acupressure as well if desired (being that a persons thumb can only consistently exert about 1-2 lbs of pressure, while effective acupressure requires about 5-lbs constant pressure). The notion of my transitional fulcrum is truly unique, its basic iteration being embodied as a dedicated Fulcrum-shoe, somewhat shovel-shaped albeit preferably flared-forward at its lower portion where it is also slightly dished as to provide a more stable and comfortable positioning, resisting otherwise tendency of the fulcrum-shoe to skew off to one side or the other; enabling my massaging-implement to be tipped-forward against the fulcrum-shoe, which itself serves to spread the load upon their frontal abdomen region, as the user moves the U-Massage™ up and down. While it is generally preferred the user be dressed in a relaxed garment, such as cotton pajamas or robe, the fulcrum-shoe is preferably made of a smooth resilient material such as shiny nylon-plastic which will easily glide-over most any clothing presenting a low-coefficient of friction. If the user desires to enjoy the U-Massage™ while unclothed, an optional insulating-mitten of lambswool, or otherwise embodying a finely-woven silk like fabric with a soft urethane-foam internal-backing. Such an insulating-mitten can be readily fitted over the fulcrum-shoe, enabling the fulcrum-shoe to pass(glide) smoothly over one's exposed-skin in a non-abrasive manner, thereby preventing chafing of one's skin; —or alternately, a lubricant such as a body-lotion or baby-oil may be applied to the body region where the uncovered fulcrum-shoe is to generally slide about.

An enhanced version of the U-Massage's™ fulcrum-shoe may employ a floating-action ball-joint or an alternate transverse/pivot-axis mounting to the terminus-holder, thereby enabling the fulcrum-shoe's face to self-adjust in angularity to the normal surface undulations of users body. Alternately, for users sensitive to the frontal-pressure imposed upon their abdomen-region by the traversing fulcrum-shoe, a substantially football shaped preferably high-comptiance pneumatic or foam-filled roller acting upon a horizontal transverse-axis can be substituted for the sliding fulcrum-shoe. In any case the notion being to substantially negate point-pressure upon the user's abdominal-region; the optional transversely-arched football-shaped roller iteration thereby also better enabling the user to cant(or rock) the vertically held U-massage™ implement at an oblique-angle either to the left or right, —as the corresponding aft massage-roller soothingly traverses likewise to-&-fro therapeutically up and down their torso-back region as directed.

Additionally, for compactness when traveling, it is preferred the fulcrum-device be mounted to the U-frame via a 2-position selectable detenting, enabling the user to simply depress a spring-loaded detent-peg protruding slightly from the U-frame, then merely rotate the Fulcrum-member body 90-degrees preferably into an alternate ¼″-diameter click-in detent-hole, —thereby rotatively repositioning the fulcrum-member in a plane parallel with the general plane of the U-frame, facilitating a more compactly folded low-profile stow-mode configuration.

B.) Another object of this invention disclosure is to set forth the U-Massage™ implement according to preceeding item-A, whereto is necessarily provided a rigid U-shaped generally tubular metal frame of steel or aluminum-alloy, although a steam-bent solid-wooden frame, or fiberglass-impregnated (for increased rididity) molded-plastic will also suffice. It is desired the U-frame member be quite rigid, so that any particular subtle increase/decrease in pressure applied initially by the user, be faithfully conveyed via the U-Masseger's aft massage-roller (or massage-nodule). While the basic Spartan-model of the U-Message™ may only employ an aft-terminus having a fixed-mount holding a 2″-3″/diam. either castering or non-castering roller, it is preferred a more delux version of the U-Massager be fitted with an aft-terminus having a ‘quick-change’ rotary-indexing turret, capable of presenting the user with several differently shaped massage-rollers, plus a so-called ‘poker-tip’ enabling more concentrated administering of acupressure. Moreover, the poker-tip can also include a potent magnet such as a rare-earth Neodymium-magnet for further therapeutic benefit, whereto in keeping with the knowledge attributable to the growing Diathetic-field of Medicine, only the positive-pole rounded-end of the magnet is directed toward the users back; and similarly, a Catalytic-kit stimulator may be offered as an option, whereby different poker-tip nodes embodying the basic elements (ie: —zink, copper, silver, gold, lithium, magnesium, chromium, iron, cadmium, nickle, lead, tin, —ect.) can be interchanged for exploration by the user of their reaction to such catalytic-acupressure therapy.

C.) Another object of this invention disclosure is to set forth the U-Massage™ implement according to preceeding items-A&B, whereto the aft-leg lower-terminus of my invention can be adapted with a conventional vibrator comprising a PM-motor which drive-axis has an eccentric-weight, thereby providing a vibro-message of variable intensity achieved by use of a substantially conventional variable-speed electronic-control (preferably not a variable-resistor but an efficient electrical-current so called ‘electronic-chopper’ device such as is commonly employed in modern electric/hand-drills) and preferably including a variable-trigger or essentially equivalent rotary thumb-wheel conveniently positioned at the front-handle region of the U-frame. In this preferably cordless vibro-message iteration of my invention, it is preferred the drycell-batteries be efficiently housed within the tubular main-frame, whereto the user can conveniently gain access to the lower/frontal-terminus of the tubular U-frame, by merely detaching the preferably push-on mounted fulcrum-shoe, thereby facilitating direct internal-access to a built-in tubular-receptacle adapted to preferably accept several preferably C-size drycell-batteries, or a single quick-change rechargable/battery-pack.

D.) Another object of this invention disclosure is to set forth the U-Massage™ implement according to preceeding items-A&B, to further include my ThermAir™ electrically-powered accessory option, essentially serving to convectively heat the aft massage-roller as to thereby enhance its therapeutic effictiveness. To facilitate quick and easy adaptation, it is preferred that a clip-on tubular housing be employed comprised of a compact L-shaped mainhousing portion having an uppermost aperture within which is arranged a 1.25-inch diameter radial-fan supported upon the drive-shaft of a conventional small high-rpm PM-motor serving to blow ambient-air coaxially down passed a simple resistance-type heating-element. The lower portion of the L-shaped housing is longitudinally-spit as to form an outlet-duct enshrouding the U-Massager's™ massage-roller when the two halfs of the outlet-duct are closed thereto; —the ducted-air is thus directed toward and around the massage-roller. While the exiting warm-air is allowed to soothingly disburse upon the user's skin, a thermo-baffle is preferably included just above the massage-roller, thereby shielding the circumferential contact-surface of the massage-roller from becoming excessively hot relative to the user's skin.

Owing to its approximate 250-watt electrical-current consumption, safe 18 v.dc-power is preferebly supplied to both the ThermAir's™ heating-element and fan/pm-motor via a plug-in service-cord preferably connected at the U-Massager's front-handle region (where an on/off-switch controls the dc-current preferably routed aftwardly within the tubular U-frame), while the opposite end of the service-cord leads to a stepdown-transformer simply pluging into an ordinary ac/line-current wall-outlet. While the service-current need not necessarily be reduced from 120-v.ac, it is much preferred that the service-cord join with the U-Massager U-frame at the frontal handle-region, where it may be routed externally along the U-frame to the aft ThermoAir™-unit; —thereby safely obviating any possibility of loose electric-cord entanglement aftward of the user's easy visual-reference. In any case, it is preferred that the ThermAir™ be controlled by a conventional momentary-type finger-switch; —thereby safely defeating operation of the ThermAir™ whenever the apparatus is set down.

E.) Another object of this invention disclosure is to set forth the U-Massage™ implement according to preceeding items-A&B, whereto another very effective electrically-powered accessory option is my Orbiotal™ massage-unit, comprising a PM-motor attached at a right-angle to the lower-terminus of the U-shaped mainframe's aft-leg, and which motor-axis is arranged aftwardly from a special Y-shaped triad thruster-yoke located oppositely at the forward-end of the rotor-housing. Three freely-rotating massage-rollers (ball-shaped, or more preferably radially 45-degree eliptical-shaped in cross-section, thus about 1.5-inches in diameter yet only about 1-inch in axial-width as to keep the orbit-head compact) are radially staged 120-degrees apart, thereby rotating in soothing massage orbit against the user's back; —which orbital-action is given an ample amount of compliance by means of a coaxial compression-spring (staged between three abaxial finger like tri-fork driving the thruster-yoke) enabling each roller to intimately albeit yieldingly follow the surface of the user's back (as for example when undulating proximal one's spinal lateral-depressions).

The PM/drive-motor is preferably controlled via a bi-directional DP/DT(center self-nulling) slide-switch best located at the front-handle of the U-frame, enabling instant reversing of the orbital-massage action according to the user's personal therapeutic tactile reversing of the orbital-massage action according to the user's personal therapeutic tactile need. Also, the motor-housing preferably includes an intermediate planetary-gear section serving to greatly reduce the rotation-speed down to preferably only about 60-rpm, which gearing advantage also facilitates use of a relatively small/light-weight inexpensive conventional PM-motor. As with the preceeding Item-C embodiment, the PM-motor may be either line-current powered, or powered via rechargable drycell-battery contained within the tubular U-frame; —with the control-switch electrical-conductors being primarily routed protectively within the tubular U-frame as well. If desired, this embodiment can also be adapted with an axial-flow fan & heating-element per proceeding Item-D, so as to likewise enhance the massing action of the rollers with convected-heat.

### III.) DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the claims section annexed hereto; and accordingly, a better understanding of the invention and the variant uses is intended, by reference to the drawings, which are considered as primarily exemplary and not to be therefore construed as restrictive in nature; wherein:

FIG. 1, is a right/side-view of human, demonstrating preferred hand placement my invention in a typical manner of its usage;

FIG. 2A, is an oblique right-frontal view showing my basic overall massage apparatus, fitted with rudimentary rigid fulcrum-shoe;

FIG. 2B, is an enlarged pictorial-view showing the fore-leg's fulcrum-shoe mounting employing a transverse/pivot-axis arrangement;

FIG. 2C, is an alternate embodiment of the fore-leg's lower fulcrum-shoe mounting showing an exemplified ball-joint arrangement;

FIG. 2D, shows another alternate embodiment of the fore-leg's transitional-fulcrum member, here embodied as a transversely elongate arched-roller;

FIG. 3, is a side/elevation-view showing an optional X-clamp facilitating convenient adjustability of both the horizontal and vertical dimensions to suit any user, whereto the tighten-knob also serves as a hand-grip;

FIG. 4, is an alternate oblique pictorial-view of the mainframe, showing an optional pivotal method by which the fore/aft leg interval may be varied, plus exemplifying incremental adjustment of the telescopic fore and aft leg lengths, as well as facilitating a 90-degree rotate stow-modality for compactness during travel;

FIG. 5, is an oblique pictorial-view of the aft-leg terminus showing how a transverse-axle can be adapted with an exemplified quick-release facilitating easy interchangability of differently configured rollers, including a partial-cutaway revealing a liquid-filled thermal-roller option, plus a massaging probe is also adapted thereto;

FIG. 6A, is an oblique pictorial-view showing the aft-leg terminus substantially according to FIG. 2A albeit adapted with an optional enshrouded electrical heating-unit;

FIG. 6B, is a partial cross-sectional side/elevation-view showing an exemplified momentary/thumb-switch for controlling electrical-current routed down to the electrical component of FIG. 6A;

FIG. 7A, is an optional motorized orbital massaging-unit shown via a partial cross-sectional diagrammatic elevation-view looking toward the aft-leg longitudinal-axis;

FIG. 7B, is an auxilary-view looking toward the massage-head per Ref.—7B:7B in FIG. 7A;

FIG. 7C, exemplifies how an electrical control-switch is preferably integrated into the upper control-handle region, and reveals preferred routing of electrical conductors internally of the mainframe relative to the PM-motor of FIG. 7A.

### IV.) ITEMIZED NOMENCLATURE REFERENCES

10,10′,10″,10R/10L,10V—human, abdomen, back-region, hands: right/left, vertebrae 11a,11b,11c,11d,11e—primary-operation Ref.arrows: forward-urging, fulcrum-point, reaction-thrust, resulting-pressure, pressure-point
12′/12″,12R/12L—secondary-oper. Ref.-arrows: urging up/down, cant-urging: right/left
13,13′,13″—overall one-piece mainframe, 180-degree bend, tubular cross-section
14,14′,14″,14G—front-leg, lower-terminus, control-handle region, hand-grip
15,15′,15″,15A,15B,15T—back-leg, lower-terminus, fork, fork-axle, bore, transverse-axis
16′,16″—two-piece mainframe: straight front-leg, right-angled back-leg
17′, 17″—two-piece mainframe: X-Y slider-clamp, clamping-knob
18,18′,18″,18K—incremental detent-holes, detent-pin, telescopic-section, locking-knob
19,19′/19″,19R—action/ref.arrows: tele-action, adj.-interval: (+)/(−), Rt.angle-rotation
20,20′,20″,20Y—transitional-fulcrum: fixed-shoe, pivot-shoe, pivot-axis, support-yoke
21,21′,21″—transitional-fulcrum: omni-shoe, support-arm, ball-&-socket arrangement
22,22′,22″—transitional-fulcrum: roto-shoe, roto-axis, roto-axle mounting-yoke
23,23′—transitional-fulcrum: guide-knob, mounting-axis
24,24′,24″,24B—massage-tool: basic-roller, dual-roller, knobby-roller, rotational-bushing
25,25′,25″,25P—massage-tool: thermo-roller, hollow-cavity, thermo-gel, gen.ref.-position
26,26′,26″,26A,26H.26L—poker-tip, magnet, support-paw, support-bushing, hole, Lug
27,27′,27″,27T,27T′—retention-pin, bias-pin, detent-ball, pin-tip, ref./tip-installed
28,28′,28″,28S—thermal-shroud: overall-shroud, right-shell, left-shell, attachment-screw
29,29′,29″,29E—thermal-shroud: inlet-screen, fan, PM-motor, heating-element
30′30″—thermal-shroud: inletting-air path (ref.arrow), outletting-air path (ref.arrow)
31′,31″—thermal-shroud: 115 v.ac electrical-conductors, 12 v.dc electrical-conductors
32,32′,32″,32S—momentary-switch, external-cord, thumb-button, return-spring
33,33′,33″,33S—orbital-massager: support-housing, PM-motor, planetary-trans., drive-axis
34,34′34″,34C′/34C″—rotor-yoke, ball-roller, tri-fork, elect.-conductors: 12 v.dc/115 v.ac
35,35′,35″,35V—DP/DT-switch, switching-tab, transistor/current-chopper, variable-trigger

### V.) DETAILED DESCRIPTION OF THE PREFERRED EMBODIMENTS

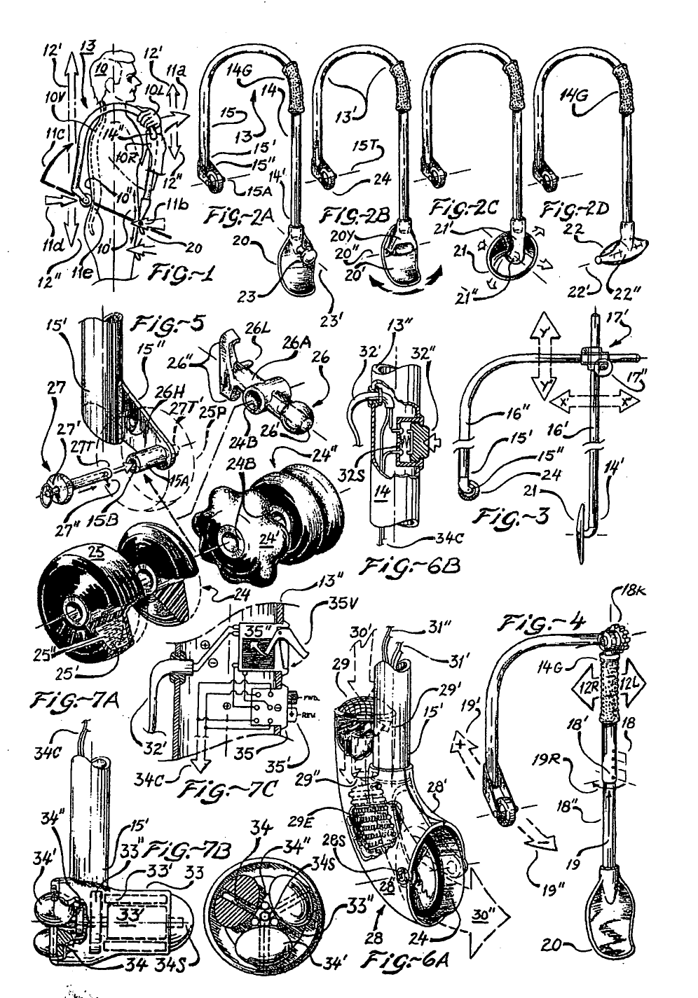

By way of most readily understanding my invention, Initial discussion is given via reference to FIGS. 1/2/3, —wherein FIG. 1 shows a standing normal human-male 10 employing my U-Massage™ implement 13, which is thus poised in a typical upright position, whereto their left-hand 10L and right-hand 10R are preferably placed upon the general control-handle region 14″ so as to thereby supportively hold the implement in its initial operating position. The user then applies a positive forward urging 11a; —thus causing the exemplified fixed-shoe 20 to react by pressing firmly against the user's abdomen-region 10′, thereby creating a novel fulcrum-point 11b, about which the back-leg 15 of the implement is reactively 11c tilted forward, thereby inducing exemplified basic-roller 24 to exert resulting-pressure 11d against the user's back-region 10″, establishing a beneficially enhanced massaging pressure-point 11e. Hence, the illustration of FIG. 1 is thus now understood to clearly reveal particularly via the presence of the bold/reference-line (with appended reaction-thrust arrow 11c) how a novel leverage-advantage is created between the fulcrum-point 11b and the pressure-point 11e; —which easily maintained resulting force 11d is substantially increased over that which could otherwise be comfortably energized and endured by conventional use of arm-muscle power alone. Therefore, it is established by way of this explanation and related drawing-figures that the essential utilitarian notion of my U-Massage™ is that of increasing the massaging force against the user's body, while at the same time reducing the heretofore fatigue involved in self-induced messaging.

There remain subtle, however vital other differences which are to become herein more evident and understood as important improvements. For example, the different exemplified configurations of sliding shoes facilitating my transitional-fulcrum principle are suggested in FIGS. 2A/2B/2C/2D; wherein FIG. 2A shows the version seen in side-view of FIG. 1 albeit with the optional provision of an auxiliary guide-knob 23 which the user 10 can grasp in either their left-hand 10L or right-hand 10R as to laterally stabilize the transitional-shoe, while simultaneously always maintaining the forward-urging 11a mentioned in the FIG. 1 explaination by holding at least one hand upon the control-handle region 14″ which is preferably fitted with a resilient textured sleeve-like hand-grip 14G. While the fixed-shoe or FIG. 2A is preferably made of molded-plastic so offers some resilence, the rocking-shoe 20′ mounted upon support-yoke 20Y shown in FIG. 2B lends greater vertical-motion compliance to body undulations; —yet the convex or dish-shaped omni-shoe of FIG. 2C mounted to support-arm 21′ offers still greater compliance, owing its ball-&-socket arrangement 21″ enableing the omni-shoe to more smoothly traverse lateral body undulations as well. However, some users will prefer the near frictionless advantage of the somewhat football-shaped roto-shoe 22 of FIG. 2D, which rotates upon a roto-axis 22′ supported by mounting-yoke 22″; —the arched-shape of the roto-shoe thus enables the user to better cant the hand-grip 14G right and left (see action ref.-arrows 12R and 12L of FIG. 4) while urging the hand-grip 14G up and down, —thereby causing the massage-roller 24 for example to work/kneed into the user's stressed back-musculature in any manner they feel desired for progressive-relief. Note that all of these different fitments of FIGS. 2A/2B/2C/2D preferably simply adapt via a snug male/female friction-fit to the tip of lower-terminus 14′, —substantially as different types of accessory pieces are often fitted to the tip conventional wand of a vacumm-cleaner. Although my basic one-piece mainframe 13 is preferred for its inherent rigidity and economy of manufacture, nevertheless alternate two-piece mainframe formations for my U-Massager™ implement are set forth in FIGS. 3 & 4, —which owing their adjustability are thereby particularly well suited to the user that is extraordinarly stout, tall or short. In the embodiment of FIG. 3, action ref.-arrows serve to demonstrate how the X-Y/slider-clamp enables the straight front-leg portion 16′ to be adjusted up/down along vertical path Y′ & Y″ so as to thereby adjust the relative length of the front-leg 16′ to suit the vertical torso-size of the user. Similarly, the back-leg portion 16″ with its right-angle downward-bend can also be simultaneously adjusted by the user to suit their particular fore/aft torso-size along horizontal path X′ & X″. This convenient adjustability is readily facilitated merely by rotating the clamping-knob 17″ counter-clockwise about half-a-turn until the captive crossed-tubes can be slid freely through the opposed-halfs of the X-Y/Slider-clamp 17′; —then when they are repositioned as desired, the clamping-knob 17″ is forcefully tightened clockwise to complete the initial personalized-adjustment procedure. Note also that once the retightened clamping-knob is firmly secured, —it may also serve as a convenient provisional hand-grip.

The other FIG. 4 generic-variant embodiment iteration addresses user torso height and girth by the cooperative combination of a pivot-axis which is securely fixed by tightening of coaxial locking-knob 18K, and a telescopic section which tele-action is shown via action/ref.-arrow 19. Accordingly, when the locking-knob 18K is unscrewed merely about half-a-turn the back-leg member 16″ can be readjusted in spacial-interval relative to the exemplified fixed-shoe 20 merely by swinging the back-leg 16″ aftward 19′ to increase the spacial-interval (see action/ref.-arrow marked: “+”); or conversely, by swinging the backleg 16″ forward 19″ decreases the spacial-interval (see action/ref.-arrow marked: “−”). Additionally, the user can extend or retract the straight front-leg 16′ as desired, simply by depressing the conventional spring-loaded detent-pin 18′ with their thumb whereby the telescopic-section 18″ can be pulled to lenthen, or pushed to shorten, according to a finite incremental plurality of detent-holes 18 provided into which the detent-pin snaps-in via spring-action applied within the telescopic-section 18″. Moreover, it should be noted that this arrangement also enables the user to push the telescopic-section 18″ entirely into the fixed upper female-tube portion while simultaneously rotating the exemplified fixed-shoe 20 90-degrees; —thereby making this U-Massage™ assembly both shorter and flatter of profile, —for ultimate compactness for stowing in a drawer or in a travel-case.

In FIG. 5 is exemplified how different types of massage-rollers can be readily interchanged so as to achieve a variety of specialized massage functions from common back-leg aft lower-trerminus 15′; simply by removing the T-shaped quick-release retention-pin 27, thereby enabling one of the provisional massaging-rollers 25P(phantom-outlined) to be thus slid freely from the approximately ½-inch diameter cantilevered fork-axle 25A. Retention-pin 27 is of conventional design, of the type having an internal coaxial bias-pin 27′ which is internally spring-loaded (coaxial compression-spring unshown) as to abaxially displace a detent-ball 27″ located proximal the pin-tip 27T; —thereby normally preventing retention-pin 27 from being removed while the displaced detent-ball 27″ is displaced radially to protrude 27T′(ref./phantom-outline) captively passed the axle's bore diameter 15B. However, when the pull-ring at the outer-extrimity of the bias-pin 27′ is pulled, the shifting bias-pin 27′ thereby allows the detent-ball 27″ to radially-receed simultaneously releasing the entire retention-pin 27 from,the axle bore 15B; —whereupon any massage-roller 25P being retained thereupon may be dismounted and an alternately selected one readily substituted as preferred (whereupon the retention-pin is reinstalled as to keep the alternate massage-roller held fast thereto.

The exemplified array of massage-rollers 24/24′/24−/25, —plus the non-rotating poker-tip 26 shown in FIG. 5, are all installed and removed in the foregoing described manner; —however, while they all preferably employ a precision-fitting Nylon-bushing 24B, each of them are quite uniquely configured as to provide different therapeutic effects. For example, the basic-roller 24 is made of a slightly resilient material such as a solid-elastomer; and as such, can be formed with a V-tapering cross-section as illustrated, —or even a relatively squarish cross-section as is depicted by the adjacently illustrated roller 25. The knobby-roller 24′ employs a plurality of preferably ball-like portions; which provide a somewhat pulsing-effect upon the user's back region 11e as the U-Massage™ implement is moved continuously up 12′ and down 12″ (ref. FIG. 1). At the far left of FIG. 5 is shown a so-called dual-roller 24″, —which serves particularly well in simultaneously massaging both sides of one's vertebrae 10V (ref. FIG. 1). The thermo-roller 25 features an annular hollow-cavity 25′ core which is permanently filled with a so-called ‘thermo-gel’ 25″ substance preferably such as a thick viscous/silicon-composition; —and as such can be preheated in a Pyrex® water-bowl placed in a conventional microwave-oven until tepid; -thus when installed immediately upon axle 15A, the effect of this proceedure is one which is exceptionally soothing to one's back-musculature.

In some instances, a user may find they rather prefer the use of interchangeable poker-tip 26, which virtue of its being of a non-rolling embodiment the user can thereby effectively work its preferably ball-shaped tip into their ailing musculature, —thereby working out the kinks in more acupuncture like manner. Additionally, some find the provision of a powerful rare-earth cylindrical magnet 26′ to be of further therapeutic benefit. Since this device is configured so as to adapt to the fork axle 15A via support-bore bushing 24B portion, it thus requires some form of anti-rotation stabilizer such as the exemplified bifurcated support-paws 26″; —or alternately as indicated, simply a single stabilizing lug 26L extending transversely from support-arm 26A portion, and mating into a hole 26H provided in the body of the fork 15″ will suffice as well.

An alternate method of providing a heated massage-roller is revealed in the illustration of FIG. 6A, which is a close-up of the standard lower-terminus 15′ and basic massage roller 24, to which has been adapted my accessory ThermAir™ option, —comprising a thermal shroud 28 housing a conventional PM-motor 29″ to which spindle is affixed a multi-bladed radial fan 29′, drawing ambient-air in through protective inlet-screen 29, so that unheated ambient-air is blown across the 115 v.ac-powered heating-element 29E (preferably configured as a ceramic-tube having a spiral-channel into which is arranged a conventional coil of tungsten-wire substantially according to ordinary hair-dryer construction), —which thus heats the incoming-air prior to its being blown upon the enshrouded standard massage-roller 24 (see assortment of FIG. 5). The thermal shroud 28 itself is simply comprised of opposed right-shell 28′ and left-shell 28″, preferably molded of a high-heat resistant glass-impregnated polymer material (having low thermal-conductivity so as to not feel hot to the touch as would a similar metal component), and is smoothly configured so as to efficiently direct the heated-air intimately around the massage roller 24 where the hot finally outletting-air is shown via reference-arrow 30″ where it can freely impinge the user's body locally for added therapeutic benefit. To maintain precise alignment, the joined R&L-shell halfs preferably employ a dove-tailed joint along their common longitudinal center-seam, and can be rigidly secured forwardly to the fork-axle via opposed machine-screw fasteners 28S; —while aftwardly the the afore mentioned inlet-screen 29 is preferably configured as a female/screw-threaded collar which is rotatively screwed down around the likewise male/screw-threaded joined shell-halfs, —thereby completing a snug air-tight fit around the lower-terminus 15′. The two electrical-conductors 31′ and 31″ (each having a pair of wires) are simply routed out the hollow-tube bottom of the lower-terminus 15′ portion of the mainframe 13 where they are connected directly to their respective electrical components prior to securing of the afore described shell-halfs. Accordingly, FIG. 6B reveals how the upper front-leg portion 14 of mainframe 13 having tubular cross-section 13″, is adapted with a critically important safety-type momentary-switch 32 with UL-approved type inletting external-cord 32′, and thumb-button 32″ cooperating with compression-type return-spring 32S. Although the fan PM-motor 29″ can optionally be circuited so as to be controlled simultaneously with the heating-element 29E, it is preferred as a safety-factor against excessive heat build-up within the shroud 28, that a seperate conventional master-switch or therma-switch (not actually shown) be included in the circuit, whereby the fan 29′ would remain activated if the massage-implement were inadvertently laid to rest (for example if the distracted user suddenly went to answer the their door-bell), —hence, as a safety-measure, thereby rapidly cooling the heating-element 29E.

In companion FIGS. 7A/7B/7C is shown another massaging option in the form of an Orbiotal™ massage-unit which is adapted to the lower-terminus 15′ of my U-Massager's™ back-leg 15 via a rigid-plastic support-housing 33 containing a conventional PM-motor 33′ which drive-axis 33S preferably drives through a planetary-transmission 33″ giving an approximate 8:1-reduction advantage in gear-ratio, so as to thereby positively rotate the tri-fork 34″ much more slowly albeit with much greater torque. Finally, the three abaxial fingers of tri-fork 34″ are positively fitted with a free-floating Y-shaped thruster-yoke 34 configured with three equally spaced apart radial-axles upon each of which freely-rotates a nylon ball-roller 34′. The three ball-rollers are thereby held captive within the surrounding cavity formed by the forward portion of the support-housing 33, while the thruster-yoke 34 has an ample amount of ‘wobble’-compliance, thereby enabling the preferably eliptically cross-sectioned ball-rollers 34′ to yieldingly follow the user's back region 11e, particularly while traversing proximal one's spine 10V and spinal lateral-depressions. Associated with the Orbiotal™ apparatus is a preferred combination of electrical-controls depicted in FIG. 7C, wherein is preferably included an external-cord 32′ feeding either 115 v.ac or 12 v.dc to a conventional transistor/current-chopper module 35″ preferably having a finger operated variable-speed trigger 35V; —and additionally, it is preferred that the PM-motor 33′ be made selectively bi-directional via manual switching-tab 35′ which simply reverses the direction of electrical-current flow through a conventional double-pole/double-throw switch 35, —all substantially in the manner common to portable electric-drill controls. While not an absolute requirement, where electrical-controls are optionally adapted to my hand-portable U-Massage™ implement, —it is much preferred for human-engineering ergonomic purposes, that the described switchs be located comfortably integrated with the hand-grip 14G.

Thus in view of the foregoing, it is readily understood how the preferred and generic-variant embodiments of this invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, in this regard it is imperative to understand that in the foregoing disclosure, the broad terms of reference-‘fulcrum-shoe’ and ‘transitional-fulcrum’ both pertain in general to the generic-variant components: 20,20′,21,22, as exemplified in FIGS. 2A/2B/2C/2D; —which constitutes the primary basis and means for improvement over the prior-art. Additionally, the broad term of reference: ‘massage-tool’ refers generally to any one of the generic-variant components: 24,24′,24″,25,34′, as are exemplified in FIGS. 5/7A/7B. Moreover, my invention has been disclosed herein by way of example, and not as imposed limitation, while the appended Claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

What is claimed of proprietary inventive origin is:

1.) A manually operated hand-portable back-massager providing improved leveraging via novel transitional-fulcrum principle, said apparatus comprising:
an inverted U-shaped rigid bar forming a front-leg portion which lower terminus supports a transitional-fulcrum means, and an back-leg portion which lower terminus supports a massage-tool means; and including an upper front-leg control-handle portion means, whereby urging said control-handle forward resultantly thrusts said transitional-fulcrum against users abdomen region and said massage-tool more forcefully against users torso-back region.

2.) The massage leveraging apparatus according to claim 1, wherein said transitional-fulcrum means is a fulcrum-shoe device formed with sufficient surface-area as to moderate point-pressure while facilitating smooth transition along user's abdomen.

3.) The massage leveraging apparatus according to claim 1, wherein said massage-tool means is a roller supported upon a transverse-axis dependent from said back-leg lower-terminus fork; said transverse-axis being adapted with a quick-release means enabling convenient interchangability of differently configured therapeutic massage-tools.

4.) An implement for self-administered back-massage, enabling advantageous leveraging via novel transitional-fulcrum principle, said apparatus comprising:
an inverted U-shaped rigid bar forming a mainframe including a front-leg and a back-leg, an upper portion of said front-leg providing a control-handle means while lower-terminus thereof includes a transitional-fulcrum means, and lower-terminus of said back-leg supports a massage-tool means; whereby user employs at least one hand to push said control-handle forward while simultaneously generally moving it in upward-and-downward motion, hence maintaining said transitional-fulcrum means against user's frontal abdomen region while thereby guiding said massage-tool means to impinge therapeutically against their torso-back region as directed.

5.) The massage leveraging apparatus according to claim 4, wherein said rigid bar can be formed from a tubular-metal or a solid-polymer.

6.) The massage leveraging apparatus according to claim 4, wherein said transitional-fulcrum device means is a fulcrum-shoe formed with sufficient surface-area as to moderate point-pressure while facilitating smooth transition along user's abdomen.

7.) The leverage fulcrum device according to claim 6, wherein the bearing-surface of said fulcrum-shoe is of a smooth polymer material, thereby providing a relatively low/coefficient-of-friction while gliding along user's abdomen region.

8.) The leverage fulcrum device according to claim 6, wherein said fulcrum-shoe is attached via a ball-joint means providing a self-adjusting floating-action facilitating a compliant transition of said fulcrum-shoe while gliding along user's abdomen region.

9.) The leverage fulcrum device according to claim 6, wherein said fulcrum-shoe device is attached via a male-female mounting means, thereby facilitating interchange-ability with other generic-variant fulcrum-shoe devices such as a low-friction football shaped roto-shoe roller.

10.) The leverage fulcrum device according to claim 6, wherein said fulcrum-shoe device is attached via male-female mounting means, thereby facilitating interchangability among generic-variant attachments.

11.) The massage leveraging apparatus according to claim 6, wherein said fulcrum-shoe device is attached via a male-female mounting means, and includes a swivel means enabling said fulcrum-shoe be alternately axially-rotated 90-degrees to a low-profile stow-position for travel compactness.

12.) The massage leveraging apparatus according to claim 4, wherein said fulcrum-shoe means is a football like arched shaped roto-shoe enabling both low-friction and comfortable rocking of the implement for enhanced massaging action.

13.) The massage leveraging apparatus according to claim 4, wherein said massage-tool means is a roller supported upon a right-angle axis dependent from said aft-leg terminus.

14.) The massage leveraging apparatus according to claim 13, wherein terminus of said axis is adapted with a coaxial quick-release means; thereby enabling convenient interchangability of differently shaped therapeutic rollers.

15.) The massage leveraging apparatus according to claim 13, wherein said roller can be adapted with a conventional vibrator-motor means, and including a conventional manually operated variable-speed control means located forwardly at said control-handle.

16.) The massage leveraging apparatus according to claim 13, wherein said roller is adapted with a partial thermal-shroud means including a contiguous housing means adapted with a conventional PM-motor driven air-blower and conventional electrical heating-element means with user selective electrical-control means, whereby heated ambient-air is directed toward said roller and upon user's back region thereto; thereby providing enhanced therapeautic-massage effect.

17.) The roller shroud apparatus according to claim 16, wherein said thermal-shroud housing is adapted to said back-leg lower-terminus via opposed longitudinally mating left and right half portions, enabling said thermal-shroud to be readily adapted to said aft-leg's said roller as an accessory option.

18.) The massage leveraging apparatus according to claim 4, wherein said massage-tool means includes a conventional PM-motor held rigidly dependent from said back-leg lower-terminus with its drive-axis arranged at a right-angle toward users back and rotating a Y-shaped thruster-yoke means which triad of radial-axes each support a ball-roller directed against users back; said PM-motor thereby providing a therapeutic orbital-action of said ball-rollers, which is selectively controlled by user via electrical-switching means located forwardly at said control-handle.

19.) The massage leveraging apparatus according to claim 4, wherein said mainframe can be comprised of continuous one-piece construction wherein said front-leg curves around 180-degrees as to thereby form the shorter said back-leg portion; or, said mainframe can be comprised of a contiguous two-piece construction wherein said front-leg is adapted with a junction means whereby a second said back-leg formed with a 90-degree angled portion is adapted to said front-leg via adjustable cojoining means.

20.) A method of manually administering back-massages via a hand-portable implement employing novel transitional-fulcrum principle, said method comprising:
providing an inverted U-shaped rigid mainframe having both a front-leg portion which supports a transitional-fulcrum means and a back-leg portion which lower-terminus supports a massage-tool means, whereby the upper-forward portion of said mainframe provides a control-handle means, by which user grasps and pushes forward upon said control-handle while simultaneously moving said control-handle in an up-and-down and laterally canted motion, all the while maintaining said transitional-fulcrum means against their forward abdomen region, thereby directing said back-leg's massage-tool means as to therapeutically impinge more heavily upon their back region than is physically possible to maintain by conventional massaging-tools.
